(19) United States
(12) Patent Application Publication
(10) Pub. No.: US 2025/0193882 A1
(43) Pub. Date: Jun. 12, 2025

(54) METHOD AND APPARATUS FOR GROUP-COMMON DCI PAYLOAD SIZE DETERMINATION

(71) Applicant: Lenovo (Beijing) Limited, Beijing (CN)

(72) Inventor: Haipeng Lei, Beijing (CN)

(73) Assignee: Lenovo (Beijing) Limited, Beijing (CN)

(21) Appl. No.: 18/697,195

(22) PCT Filed: Oct. 1, 2021
(86) PCT No.: PCT/CN2021/122490

§ 371 Date: Mar. 29, 2024

(51) Int. Cl. H04W 72/1273; H04L 1/1812; H04L 5/00; H04W 72/232

(52) U.S. Cl. CPC H04W 72/1273; H04L 1/1812; H04L 5/0055; H04W 72/232

(57) ABSTRACT

Embodiments of the present disclosure relate to methods and apparatuses for DCI payload size determination. According to some embodiments of the disclosure, a user equipment (UE) may receive a signaling message indicating a payload size of a first downlink control information (DCI) format for scheduling a downlink (DL) transmission, wherein the first DCI format and the DL transmission are common to a group of UEs including the UE. The UE may receive the first DCI format based on the indicated payload size.

### TECHNICAL FIELD

Embodiments of the present disclosure generally relate to wireless communication technology, and more particularly to downlink control information (DCI) payload size determination.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

A wireless communication system may support multicast and broadcast services (MBSs). One or more user equipment (UE) may be grouped as an MBS group and may receive multicast transmissions from a base station (BS) via a physical downlink shared channel (PDSCH). The multicast transmissions may be scheduled by downlink control information (DCI).

Moreover, a UE may blindly search a DCI, which may either schedule a multicast transmission or a unicast transmission, transmitted over a physical downlink control channel (PDCCH). The search performed by the UE is problematic in that one or more decoding attempts are performed based on a hypothetical PDCCH located in a time-frequency location known as a search space. When the UE performs a decoding attempt, it assumes a certain size of the DCI. This means that when the UE tries to find two sizes of DCI, e.g., a larger DCI and a smaller DCI, the UE needs to perform two decoding attempts. Therefore, a DCI size threshold value (or DCI size budget) is required to control the blind detection. To achieve the DCI size budget, DCI size alignment may be performed.

There is a need for determining the payload size of a DCI scheduling multicast transmission and handling DCI size alignment in a wireless communication system.

### SUMMARY

Some embodiments of the present disclosure provide a user equipment (UE). The UE may include: a transceiver; and a processor coupled to the transceiver. The processor may be configured to: receive a signaling message indicating a payload size of a first downlink control information (DCI) format for scheduling a downlink (DL) transmission, wherein the first DCI format and the DL transmission are common to a group of UEs including the UE; and receive the first DCI format based on the indicated payload size.

Some embodiments of the present disclosure provide a user equipment (UE). The UE may include: a transceiver; and a processor coupled to the transceiver. The processor may be configured to: receive configuration information related to fields of a first downlink control information (DCI) format scheduling a downlink (DL) transmission, wherein the first DCI format and the DL transmission are common to a group of UEs including the UE; determine the first DCI format and a payload size of the first DCI format based on the configuration information; and receive the first DCI format based on the determined payload size.

Some embodiments of the present disclosure provide a user equipment (UE). The UE may include: a transceiver; and a processor coupled to the transceiver. The processor may be configured to: for each field in a non-fallback downlink control information (DCI) format for scheduling a downlink (DL) transmission, determine the largest possible size of a corresponding field of the non-fallback DCI format as the size of the corresponding field; determine a payload size of the non-fallback DCI format based on the determined size of each field in the non-fallback DCI format; and receive the non-fallback DCI format based on the determined payload size.

Some embodiments of the present disclosure provide a base station (BS). The BS may include: a transceiver; and a processor coupled to the transceiver. The processor may be configured to: transmit, to a user equipment (UE), a signaling message indicating a payload size of a first downlink control information (DCI) format for scheduling a downlink (DL) transmission, wherein the first DCI format and the DL transmission are common to a group of UEs including the UE; and transmit the first DCI format based on the indicated payload size.

In some embodiments, Hybrid automatic repeat request acknowledgement (HARQ-ACK) feedback related fields in the first DCI format may be arranged at the end of the first DCI format. For example, the HARQ-ACK feedback related fields in the first DCI format may be arranged at the end of the first DCI format in an order based on their usage frequencies among different HARQ-ACK feedback options.

In some embodiments, the processor may be further configured to: determine the first DCI format based on configuration information for the DL transmission; and add a padding bit(s) to the determined first DCI format until the size of the determined first DCI format is equal to the indicated payload size.

In some examples, the indicated payload size may be: the maximum size among all non-fallback DCI formats for scheduling DL transmission with cyclic redundancy checks (CRCs) scrambled by UE-specific radio network temporary identifiers (RNTIs) of the group of UEs and the determined first DCI format; the maximum size among all non-fallback DCI formats for scheduling DL transmission with CRCs scrambled by UE-specific RNTIs of the group of UEs; or the maximum size among all DCI format 2_X series with CRCs scrambled by corresponding RNTIs of the group of UEs. In some examples, the signaling message may further indicate the UE to perform a size alignment between a non-fallback DCI format for scheduling a uplink (UL) transmission with a cyclic redundancy check (CRC) scrambled by a radio network temporary identifier (RNTI) specific to the UE and a non-fallback DCI format for scheduling a DL transmission with a CRC scrambled by the RNTI specific to the UE. The indicated payload size may be the maximum size among all non-fallback DCI formats for scheduling DL transmission with CRCs scrambled by group-common RNTIs of the group of UEs.

Some embodiments of the present disclosure provide a base station (BS). The BS may include: a transceiver; and a processor coupled to the transceiver. The processor may be configured to: transmit, to a user equipment (UE), configuration information related to fields of a first downlink control information (DCI) format scheduling a downlink (DL) transmission, wherein the first DCI format and the DL transmission are common to a group of UEs including the UE; determine the first DCI format and a payload size of the first DCI format based on the configuration information; and transmit the first DCI format based on the determined payload size.

The configuration information may indicate: whether a hybrid automatic repeat request acknowledgement (HARQ-ACK) feedback related field for the DL transmission is present or not in the first DCI format; or whether a combination of at least two HARQ-ACK feedback related fields for the DL transmission is present or not in the first DCI format. The configuration information may be transmitted in a system information block (SIB), a multicast control channel (MCCH), or a UE-specific radio resource control (RRC) signaling.

At least one hybrid automatic repeat request acknowledgement (HARQ-ACK) related field in the first DCI format may be reused for a frequency domain resource allocation (FDRA) indication in the first DCI format based on a predefined or configured order.

The configuration information may indicate a corresponding size for each field with a configurable size in the first DCI format. The processor may be further configured to determine the maximum size of a field with a configurable size in the first DCI format among all non-fallback DCI formats for scheduling DL transmission with CRCs scrambled by group-common radio network temporary identifiers (RNTIs) of the group of UEs as the size of the field.

Some embodiments of the present disclosure provide a base station (BS). The BS may include: a transceiver; and a processor coupled to the transceiver. The processor may be configured to: for each field in a non-fallback downlink control information (DCI) format for scheduling a downlink (DL) transmission, determine the largest possible size of a corresponding field of the non-fallback DCI format as the size of the corresponding field; and determine a payload size of the non-fallback DCI format based on the determined size of each field in the non-fallback DCI format; and transmit the non-fallback DCI format based on the determined payload size.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIG. 2 illustrates a flow chart of an exemplary procedure of wireless communications in accordance with some embodiments of the present disclosure;

FIG. 3 illustrates a flow chart of an exemplary procedure of wireless communications in accordance with some embodiments of the present disclosure;

FIG. 4 illustrates a flow chart of an exemplary procedure of wireless communications in accordance with some embodiments of the present disclosure;

FIG. 5 illustrates a flow chart of an exemplary procedure of wireless communications in accordance with some embodiments of the present disclosure; and

FIG. 6 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under specific network architecture and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

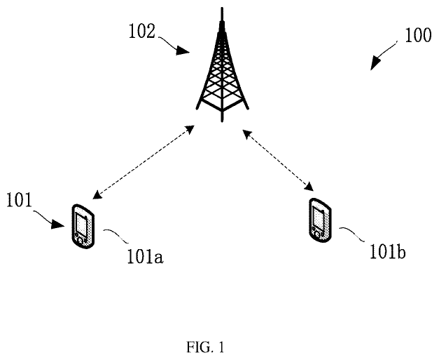

FIG. 1 illustrates a schematic diagram of a wireless communication system 100 in accordance with some embodiments of the present disclosure.

As shown in FIG. 1, a wireless communication system 100 may include some UEs 101 (e.g., UE 101a and UE 101b) and a base station (e.g., BS 102). Although a specific number of UEs 101 and BS 102 are depicted in FIG. 1, it is contemplated that any number of UEs and BSs may be included in the wireless communication system 100.

The UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, the UE(s) 101 includes wearable devices, such as smart watches, fitness bands, optical head-mounted displays, or the like. Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. The UE(s) 101 may communicate with the BS 102 via uplink (UL) communication signals.

The BS 102 may be distributed over a geographic region. In certain embodiments of the present disclosure, the BS 102 may also be referred to as an access point, an access terminal, a base, a base unit, a macro cell, a Node-B, an evolved Node B (eNB), a gNB, a Home Node-B, a relay node, or a device, or described using other terminology used in the art. The BS 102 is generally a part of a radio access network that may include one or more controllers communicably coupled to one or more corresponding BSs 102. The BS 102 may communicate with UE(s) 101 via downlink (DL) communication signals.

The wireless communication system 100 may be compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, the wireless communication system 100 is compatible with 5G NR of the 3GPP protocol. For example, BS 102 may transmit data using an orthogonal frequency division multiple (OFDM) modulation scheme on the DL and the UE(s) 101 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, the BS 102 and UE(s) 101 may communicate using other communication protocols, such as the IEEE 802.11 family of wireless communication protocols. Further, in some embodiments of the present disclosure, the BS 102 and UE(s) 101 may communicate over licensed spectrums, whereas in some other embodiments, the BS 102 and UE(s) 101 may communicate over unlicensed spectrums. The present disclosure is not intended to be limited to the implementation of any particular wireless communication system architecture or protocol.

In some embodiments of the present disclosure, the wireless communication system 100 may support multicast and broadcast services (MBSs). For example, one or more UEs (e.g., UE 101a and UE 101b) may be grouped as an MBS group to receive MBSs (e.g., an MBS PDSCH) from a BS (e.g., BS 102).

A group-common radio network temporary identifier (RNTI) (e.g., group-RNTI (G-RNTI)) is introduced for an MBS so that a UE can differentiate a DCI scheduling a group-common PDSCH carrying an MBS service (e.g., an MBS PDSCH) from a DCI scheduling UE-specific PDSCH carrying a unicast service. For example, the cyclic redundancy check (CRC) of the DCI scheduling the group-common PDSCH may be scrambled by G-RNTI and the scheduled group-common PDSCH carrying the MBS may also be scrambled by the G-RNTI. The CRC of the DCI scheduling the unicast PDSCH may be scrambled by a UE-specific RNTI (e.g., cell-RNTI (C-RNTI)) and the scheduled unicast PDSCH may also be scrambled by the UE-specific RNTI.

In some embodiments, two DCI formats, hereinafter denoted as DCI format #1 and DCI format #2, can be used for the group-common PDCCH (GC-PDCCH). DCI format #1 may take a fallback DCI format, such as DCI format 1_0, as a baseline and DCI format #2 may take a non-fallback DCI format, such as DCI format 1_1, as a baseline.

According to 3GPP protocols, a “3+1” DCI size budget should be satisfied. That is, for a cell, the total number of different DCI sizes with a C-RNTI (hereinafter, “C-RNTI DCI size”) is no more than 3, and the total number of different DCI sizes (including C-RNTI DCI size(s) and other RNTI DCI size(s)) is no more than 4. “Other RNTI DCI size” refers to the size of a DCI scrambled by an RNTI other than a C-RNTI. To achieve the DCI size budget, the following agreement has been reached by the 3GPP: for multicast of RRC-CONNECTED UEs, the size of the format #1 for GC-PDCCH may be aligned with fallback DCI format (e.g., DCI format 1_0) with a CRC scrambled by a UE-specific RNTI and monitored in a common search space (CSS).

Table 1 below shows an exemplary DCI format 1_0 with the CRC scrambled by C-RNTI.

TABLE 1
Fields of DCI format 1_0 with the CRC scrambled by C-RNTI

| DCI field | Size (bits) |
|---|---|
| Identifier for DCI formats | 1 |
| Frequency domain resource | ┌log₂(N_{RB}^{DL,B} [symbol] ^{P}(N_{RB}^{DL,BWP} + 1)/2┐ |
| assignment | where N_{RB}^{DL,BWP} is the number of |
| | RBs of control resource set |
| | (CORESET) 0 or initial DL BWP |
| Time domain resource | 4 |
| assignment (FDRA) | |
| VRB-to-PRB mapping | 1 |
| Modulation and coding | 5 |
| scheme | |
| New data indicator | 1 |
| Redundancy version | 2 |
| Hybrid Automatic Repeat | 4 |
| Request (HARQ) process | |
| number | |
| Downlink assignment | 2 |
| index (DAI) | |
| TPC command for | 2 |
| scheduled PUCCH | |
| PUCCH resource indicator | 3 |
| (PRI) | |
| PDSCH-to-HARQ_feedback | 3 |
| timing indicator | |

[symbol]

indicates data missing or illegible when filed

In the above Table 1, the last four fields, i.e., DAI field, transmission power control (TPC) field, PRI field, PDSCH-to-HARQ_feedback timing indicator field, are examples of HARQ-ACK feedback related fields. It should be understood that Table 1 is only for illustrative purposes, and should not be construed as limiting the embodiments of the present disclosure. For example, a DCI format 1_0 may include fewer or more DCI fields in some other embodiments of the present disclosure. The bit size of one or more DCI fields in Table 1 may be different in some other embodiments of the present disclosure.

As mentioned above, the payload size of DCI format #1 for the GC-PDCCH may be equal to that of DCI format 1_0 with the CRC scrambled by C-RNTI which is monitored in CSS. In this case, DCI format #1 may also be referred to as DCI format 1_0 with the CRC scrambled by group-common RNTI (hereinafter may use G-RNTI as an example for simplicity). DCI format 1_0 for unicast may be referred to as DCI format 1_0 with the CRC scrambled by UE-specific RNTI (hereinafter may use C-RNTI as an example for simplicity). It is noted that DCI format 1_0 with a CRC scrambled by G-RNTI for an MBS may not have exactly the same fields as DCI format 1_0 with a CRC scrambled by C-RNTI for a unicast PDSCH. For example, the one-bit identifier may not exist in DCI format 1_0 with a CRC scrambled by G-RNTI as this G-RNTI scrambled DCI format is always used for DL scheduling. However, as a general principle, the payload size of DCI format 1_0 with a CRC scrambled by a G-RNTI is aligned with the payload size of DCI format 1_0 with a CRC scrambled by a C-RNTI.

On the other hand, the HARQ-ACK feedback from UEs corresponding to a downlink multicast transmission is essential for the multicast services in order to satisfy the QoS requirement, e.g., reliability. There are, for example, four HARQ-ACK feedback options for a PDSCH carrying a multicast service, which are listed below:
Option 1: Group NACK-only transmission
   If the PDSCH is successfully received, then a UE does not transmit an acknowledgement (ACK) to the BS.
   If the PDSCH is not successfully received, then a UE transmits a negative ACK (NACK) to the BS.
   A group of UEs share the same resource to transmit the NACK.
Option 2: UE-specific NACK-only transmission
   If the PDSCH is successfully received, then a UE does not transmit an ACK feedback to the BS.
   If the PDSCH is not successfully received, then a UE transmits an NACK to the BS.
   Each UE is provided with a specific PUCCH resource for the UE to transmit the NACK to the BS.
Option 3: UE-specific ACK/NACK transmission
   If the PDSCH is successfully received, then a UE transmits an ACK feedback to the BS.
   If the PDSCH is not successfully received, then a UE transmits an NACK to the BS.
   Each UE is provided with a specific PUCCH resource for the UE to transmit an ACK/NACK to the BS.
Option 4: Disabled HARQ-ACK feedback
   No HARQ-ACK feedback is transmitted regardless of whether the PDSCH is successfully received or not.
   No PUCCH resource is needed.

Different HARQ-ACK feedback options may have different requirements on HARQ related fields in the group-common DCI with the CRC scrambled by the group-common RNTI. For example, assuming that Table 1 is used as a baseline for DCI format #1 as the group-common DCI, when HARQ-ACK feedback option 4 is employed, at least 2 bits DAI, 2 bits TPC, 3 bits PRI and 3 bits HARQ-ACK timing indicator may not be needed in the group-common DCI since these fields are applied only for enabled HARQ-ACK feedback. When HARQ-ACK feedback option 1 is employed, at least 2 bits DAI, 3 bits PRI and 2 bits TPC may not be needed. When HARQ-ACK feedback option 2 is employed, at least 3 bits PRI and 2 bits TPC may not be needed. When HARQ-ACK feedback option 3 is employed, all the HARQ related fields may be needed. As a consequence, different HARQ-ACK feedback options may result in different payload sizes of the group-common DCI (before padding).

RRC signaling may be used to enable or disable the HARQ-ACK feedback per UE basis. For example, some UEs at the cell center may have good channel experience so that they may not need any HARQ-ACK feedback, and some UEs at the cell edge may have worse channel experience so that they may need HARQ-ACK feedback for reliability improvement. Since different HARQ-ACK feedback options may lead to different payload sizes, an issue to be solved is how to transmit a group-common DCI for a group of UEs when different member UEs may be configured with different HARQ-ACK feedback options. For example, a UE with disabled HARQ-ACK feedback may assume there are no HARQ-ACK related fields in the group-common DCI. A UE with enabled HARQ-ACK feedback option 1 may assume that there are no DAI, PRI and TPC in the group-common DCI. A UE with enabled HARQ-ACK feedback option 2 may assume that there are no PRI and TPC in the group-common DCI. A UE with enabled HARQ-ACK feedback option 3 may assume that all the HARQ-ACK feedback related fields exist in the group-common DCI. In that sense, a UE cannot detect the group-common DCI when the assumed payload size is different from that transmitted by a BS. Embodiments of the present disclosure provide solutions to solve the above issues.

In some embodiments, all the UEs in the same group may assume the maximum DCI payload size which takes all the HARQ related fields into account for detecting the group-common DCI. Correspondingly, a BS may transmit the group-common DCI with all the HARQ related fields. In this way, the group of UEs can have the same understanding on the group-common DCI. A member UE with disabled HARQ-ACK feedback may not know whether other member UEs in the same group are configured with disabled HARQ-ACK feedback or which HARQ-ACK feedback option is enabled. As a result, the UE with disabled HARQ-ACK feedback has to always assume that HARQ-ACK feedback related fields exist in the DCI while neglects those fields after receiving the DCI. A drawback of the above method is too much overhead is included in the group-common DCI when, for example, there is no UE with enabled HARQ-ACK feedback in the group. For example, at least 10 bits may be totally unused in this case.

Embodiments of the present disclosure provide enhanced solutions to solve the above issues. For example, solutions for payload size determination for group-common DCI are proposed. For example, solutions for payload size determination based on HARQ-ACK feedback options are proposed. On the other hand, after introducing DCI format #1 and DCI format #2 for group-common DCI, the “3+1” DCI size budget should still be satisfied. Embodiments of the present disclosure provide solutions for DCI size alignment when DCI format #1 and DCI format #2 for the group-common DCI are introduced. More details on the embodiments of the present disclosure will be illustrated in the following text in combination with the appended drawings.

In some embodiments of the present disclosure, for a group of UEs receiving a multicast service, an indication indicating the existence of each HARQ-ACK feedback related field in a DCI format #1 or whether the size of a HARQ-ACK feedback related field in the DCI format #1 is zero may be introduced. Such indication may be carried by radio resource control (RRC) signaling, message(s) or parameter(s). That is, whether a HARQ-ACK feedback related field is included or not in the DCI format #1 may be dependent on an RRC signaling configuration.

Table 2 below shows an exemplary DCI format 1_0 with the CRC scrambled by a G-RNTI (DCI format #1). It should be understood that Table 2 is only for illustrative purposes, and should not be construed as limiting the embodiments of the present disclosure.

TABLE 2
Fields of DCI format 1_0 with the CRC scrambled by a G-RNTI

| DCI field | Size (bits) |
|---|---|
| Frequency domain resource | Dependent on the common |
| assignment | frequency resource (CFR) |
| | configuration, either |
| | CORESET 0 or initial DL |
| | bandwidth part (BWP) |
| Time domain resource | 4 |
| assignment | |
| VRB-to-PRB mapping | 1 |
| Modulation and coding scheme | 5 |
| New data indicator | 1 |
| Redundancy version | 2 |
| HARQ process number | 4 |
| Downlink assignment index | 2 or 0 dependent on the |
| | BS's configuration |
| TPC command for scheduled | 2 or 0 dependent on the |
| PUCCH | BS's configuration |
| PUCCH resource indicator | 3 or 0 dependent on the |
| | BS's configuration |
| PDSCH-to-HARQ_feedback | 3 or 0 dependent on the |
| timing indicator | BS's configuration |

For a group of UEs, when, for example, the reliability requirements of an MBS service are low or the group of UEs are located at the cell center with good channel experience, all the UEs in the group can be configured with disabled HARQ-ACK feedback. Accordingly, the BS can use an RRC signaling to separately indicate that each of the HARQ related fields (e.g., DAI, TPC, PRI, HARQ timing indicator) is not included in the group-common DCI. Alternatively, the signaling may indicate that the size of each HARQ related field is equal to zero.

When, for example, some UEs at the cell center are configured with disabled HARQ-ACK feedback, and some UEs at the cell edge are configured with HARQ-ACK feedback option 1, the BS can use RRC signaling to separately indicate that some HARQ-ACK feedback related fields (e.g., DAI, TPC, and PRI) are not included in the group-common DCI while some other HARQ-ACK feedback related fields (e.g., HARQ timing indicator) are included in the group-common DCI. Alternatively, the RRC signaling may indicate that, for example, zero-bit DAI, zero-bit TPC, zero-bit PRI and 3-bit HARQ timing indicator are included in the group-common DCI.

When, for example, some UEs at the cell center are configured with disabled HARQ-ACK feedback, and some UEs at the cell edge are configured with HARQ-ACK feedback option 2, the BS can use RRC signaling to separately indicate that some HARQ-ACK feedback related fields (e.g., TPC and PRI) are not included in the group-common DCI while some other HARQ-ACK feedback related fields (e.g., DAI and HARQ timing indicator) are included in the group-common DCI. Alternatively, the RRC signaling may indicate that, for example, 2-bit DAI, zero-bit TPC, zero-bit PRI and 3-bits HARQ timing indicator are included in the group-common DCI.

When some UEs at the cell center are configured with disabled HARQ-ACK feedback, and some UEs at the cell edge are configured with HARQ-ACK feedback option 3, the BS can use RRC signaling to separately indicate that all HARQ-ACK feedback related fields (e.g., DAI, TPC, PRI, and HARQ timing indicator) exist in the group-common DCI. Alternatively, the RRC signaling may indicate that, for example, 2-bit DAI, 2-bit TPC, 2-bit PRI and 3-bit HARQ timing indicator are included in the group-common DCI.

For example, referring to FIG. 1, UE 101a may be located at the cell center and may be configured with disabled HARQ-ACK feedback. UE 101b may be located at the cell edge and may be configured with enabled HARQ-ACK feedback option 1, 2 or 3.

In some embodiments, the indication which indicates the existence of each HARQ-ACK feedback related field may be transmitted in a system information block (SIB) (e.g., SIB-1 or MBS-specific SIB message) or a multicast control channel (MCCH). In some embodiments, such indication may be transmitted in a UE-specific RRC signaling.

In some embodiments, when the CFR is larger than CORESET 0 (if CORESET 0 is configured in the serving cell) or an initial DL BWP (if CORESET 0 is not configured in the serving cell), in response to one or more HARQ-ACK related fields being not needed or reserved (e.g., when HARQ-ACK feedback option 1, 2, or 4 is configured), the reserved fields can be reused for indicating the FDRA within the CFR. An order may be predefined or configured for reusing the HARQ-ACK related fields. For example, the TPC field may be firstly reused if needed, the PRI field may be secondly reused after reusing the TPC field, the DAI field may be thirdly reused after reusing the PRI field, and the HARQ-ACK feedback timing indicator field may be fourthly reused after reusing the DAI field. In some embodiments, the specific field(s) being reused may be based on the CFR configuration and the bandwidth of CORESET 0 or initial DL BWP as well as the reusing order.

Based on the BS's configuration, a UE can know whether a HARQ-ACK related field is included in the group-common DCI or not. Thus, the UE can determine the field sizes, as well as the payload size, of the group-common DCI. When the CFR is larger than CORESET 0 (if CORESET 0 is configured in the serving cell) or initial DL BWP (if CORESET 0 is not configured in the serving cell), the UE can further determine which HARQ-ACK feedback related fields can be reused for indicating the FDRA within the CFR.

In some other embodiments of the present disclosure, instead of separately indicating the existence of each HARQ-ACK feedback related field in the group-common DCI, the signaling, message or parameter may indicate the existence of a combination of at least two HARQ-ACK feedback related fields in the group-common DCI. For example, the value of the indication being “1” may indicate that the combination of two or more HARQ-ACK feedback related fields (e.g., DAI, TPC, PRI, and HARQ timing indicator) is included in the group-common DCI; and the value of the indication being “0” may indicate that the combination of the two or more HARQ-ACK feedback related fields (e.g., DAI, TPC, PRI, and HARQ timing indicator) is not included in the group-common DCI.

In yet other embodiments of the present disclosure, instead of indicating the configuration information related to fields of the group-common DCI as described above, the payload size of the group-common DCI may be indicated by the RRC signaling, message or parameter. In some examples, in order to avoid any misunderstanding between UEs with enabled HARQ-ACK feedback (e.g., any of HARQ-ACK feedback options 1-3) and UEs with disabled HARQ-ACK feedback (e.g., HARQ-ACK feedback option 4) on the HARQ-ACK feedback related fields, all the HARQ-ACK feedback related fields may be arranged at the end of the group-common DCI.

Table 3 below shows an exemplary DCI format 1_0 with the CRC scrambled by a G-RNTI (DCI format #1). It should be understood that Table 3 is only for illustrative purposes, and should not be construed as limiting the embodiments of the present disclosure.

TABLE 3
Fields of DCI format 1_0 with the CRC scrambled by a G-RNTI

| DCI field | Size (bits) |
|---|---|
| Frequency domain resource | Dependent on CFR |
| assignment | configuration, either |
| | CORESET 0 or initial DL |
| | BWP |
| Time domain resource | 4 |
| assignment | |
| VRB-to-PRB mapping | 1 |
| Modulation and coding scheme | 5 |
| New data indicator | 1 |
| Redundancy version | 2 |
| HARQ process number | 4 |
| PDSCH-to-HARQ_feedback | 3 or 0 dependent on the |
| timing indicator | HARQ-ACK feedback option |
| Downlink assignment index | 2 or 0 dependent on the |
| | HARQ-ACK feedback option |
| PUCCH resource indicator | 3 or 0 dependent on the |
| | HARQ-ACK feedback option |
| TPC command for scheduled | 2 or 0 dependent on the |
| PUCCH | HARQ-ACK feedback option |

Furthermore, in order to avoid any misunderstanding among UEs with different enabled HARQ-ACK feedback options, for example, among UEs with enabled group NACK-only, UE-specific NACK-only and UE-specific ACK/NACK feedback, the HARQ-ACK feedback related fields in the group-common DCI format may be arranged at the end of the DCI format in an order based on their usage frequencies among different HARQ-ACK feedback options.

For example, the most common fields among different feedback options are placed firstly and then followed by less common fields. For instance, each enabled HARQ-ACK feedback option requires HARQ-ACK feedback timing indicator, so this field may be placed firstly and then followed by the DAI field because each enabled HARQ-ACK feedback option requires the DAI when HARQ-ACK multiplexing is configured. The PRI field may be placed after the DAI field since UE-specific ACK/NACK feedback requires the PRI. Since TPC field may not be useful for each enabled HARQ-ACK feedback option, it may be placed at the end or the beginning of all the HARQ-ACK feedback related fields.

For a UE receiving multiple MBS services, group-common DCIs with the same format (e.g., DCI format #1) may be used to schedule PDSCHs carrying different MBS services. Different group-common RNTIs may be used to differentiate different group-common DCI for different MBS services. The group-common DCI format (e.g., DCI format #1) should have the same payload size corresponding to the multiple MBS services. As long as one of the multiple MBS services requires HARQ-ACK feedback for reliability improvement, the group-common DCI format (e.g., DCI format #1) should include corresponding HARQ-ACK feedback related fields in the DCI format so there is a unified payload size among the group-common DCI format (e.g., DCI format #1) for the multiple MBS services.

As mentioned above, DCI format #2 may take a non-fallback DCI format (hereinafter taking DCI format 1_1 as an example for simplicity) as a baseline. In the example, DCI format #2 may also be referred to as DCI format 1_1 with the CRC scrambled by a group-common RNTI (hereinafter taking G-RNTI as an example for simplicity) and DCI format 1_1 for unicast may be referred to as DCI format 1_1 with a CRC scrambled by a UE-specific RNTI (hereinafter taking C-RNTI as an example for simplicity).

In some embodiments, to keep the “3+1” size budget, the size of DCI format #2 may be aligned with the size of DCI format 1_1 with the CRC scrambled by the C-RNTI. Since most of DCI format 1_1 fields are configurable, in order to determine the payload size of DCI format #2, following embodiments are provided for the UE to determine each field size of DCI format 1_1 with the CRC scrambled by the C-RNTI, so as to determine its payload size and assume the same payload size for DCI format 1_1 with a CRC scrambled by a G-RNTI. Since both DCI format #1 and DCI format #2 can be used for group-common PDCCH, DCI format #1 can be configured as the default DCI format and whether to detect DCI format #2 is determined by an RRC configuration.

In some embodiments, each field with a configurable size may be assumed to have the largest possible size regardless of the relevant configuration or capability of the UE. In this way, all the UEs in the same group can have the same understanding on the payload size. For example, for the BWP indicator in DCI format 1_1, the possible field size is 0, 1 or 2 bits as determined based on the number of DL BWPs of a UE. Usually, for a UE configured with 1 DL BWP, the UE may assume 0 bit for the BWP indicator field; for a UE configured with 2 DL BWPs, the UE may assume 1 bit for the BWP indicator field; and for a UE configured with 3 or 4 DL BWPs, the UE may assume 2 bits for the BWP indicator field. In these embodiments, since the largest possible size for BWP indicator is 2, each UE in the group may assume 2 bits as the field size of the BWP indicator no matter how many DL BWPs are configured for the corresponding UE.

In some other embodiments, the size of each field with a configurable size may be explicit configured to member UEs by the BS so as to avoid any ambiguity. For example, the BS may transmit configuration information indicating the concrete size of each field with a configurable size. At the BS side, the size of a field with a configurable size may be determined as the maximum size of this field among all non-fallback DCI formats (e.g., DCI format 1_1s) for the group of UEs, and may be indicated to each member UE in the group.

For example, as mentioned above, for the BWP indicator in DCI format 1_1, the possible field size is 0, 1 or 2 bits as determined according to the number of DL BWPs. In these embodiments, for a group of UEs, assuming the maximum number of DL BWPs configured among the group of UEs is 2 (for example, some UEs in the group may be configured with 1 DL BWP and the remaining UEs in the group may be configured with 2 DL BWPs; that is to say, no UE in the group is configured with more than 2 DL BWPs), then the BS can explicitly indicate the field size of BWP indicator as 1. In response to the reception of the indication of the one-bit size for BWP indicator, each UE in the group assumes 1 bit as the field size of the BWP indicator, no matter how many DL BWPs are configured for the corresponding UE.

Table 4 below shows an exemplary DCI format 1_1 with the CRC scrambled by a G-RNTI (DCI format #2). It should be understood that Table 4 is only for illustrative purposes, and should not be construed as limiting the embodiments of the present disclosure. For the FDRA field, the number of required bits is determined based on the number of resource blocks (RBs) in the CFR so that all the UEs in the group have the same understanding on FDRA field size.

TABLE 4
Fields of DCI format 1_1 with the CRC scrambled by a G-RNTI

| DCI field | Size (bits) |
|---|---|
| Bandwidth part indicator | 0, 1 or 2 bits as determined by DL BWP |
| | configurations among all member UEs |
| Frequency domain resource assignment | number of bits determined by CFR |
| Time domain resource assignment | 0, 1, 2, 3, or 4 bits as determined by the |
| | number of entries in the higher layer |
| | parameter |
| | pdsch-TimeDomainAllocationList |
| VRB-to-PRB mapping | 0 or 1 bit |
| PRB bundling size indicator | 0 or 1 bit |
| Rate matching indicator | 0, 1, or 2 bits |
| ZP CSI-RS trigger | 0, 1, or 2 bits |
| Modulation and coding scheme for TB1 | 5 |
| New data indicator for TB1 | 1 |
| Redundancy version for TB1 | 2 |
| Modulation and coding scheme for TB2 | 5 |
| (only present if | |
| maxNrofCodeWordsScheduledByDCI | |
| equals 2) | |
| New data indicator for TB2 (only present if | 1 |
| maxNrofCodeWordsScheduledByDCI | |
| equals 2) | |
| Redundancy version for TB2 (only present | 2 |
| if maxNrofCodeWordsScheduledByDCI | |
| equals 2) | |
| HARQ process number | 4 |
| Downlink assignment index | 0, 2, 4, or 6 bits |
| TPC command for scheduled PUCCH | 2 bits |
| PUCCH resource indicator | 3 bits |
| PDSCH-to-HARQ_feedback timing | 0, 1, 2, or 3 bits |
| indicator | |
| . . . | . . . |

In some embodiments of the present disclosure, for a group of UEs receiving a multicast service, an indication indicating the payload size of DCI format #2 may be introduced. Such indication may be carried by RRC signaling, message(s) or parameter(s). For example, the exact payload size of DCI format 1_1 with the CRC scrambled by G-RNTI may be configured by RRC signaling. Various methods may be employed by the BS to determine the payload size of DCI format #2.

For example, in a first embodiment of the present disclosure, the payload size of DCI format #2 may be determined as the maximum size of all non-fallback DCI formats for scheduling DL transmission (e.g., DCI format 1_1s) with CRCs scrambled by UE-specific RNTIs (hereinafter, taking C-RNTI as an example for simplicity) (prior to padding) among the group of UEs and the payload size of DCI format #2 (prior to padding) (e.g., DCI format 1_1 with the CRC scrambled by G-RNTI). In a second embodiment of the present disclosure, the payload size of DCI format #2 may be determined as the maximum size of all non-fallback DCI formats for scheduling DL transmission (e.g., DCI format 1_1s) with CRCs scrambled by C-RNTIs (prior to padding) among the group of UEs.

In the above embodiments, after determining the payload size of DCI format #2, the BS may indicate the payload size to the group of UEs via RRC signaling, message or parameter. In response to the reception of the size, each UE in the group may add a padding bit(s) (e.g., appending a zero bit(s)) to its respective non-fallback DCI format for scheduling DL transmission (e.g., DCI format 1_1) with the CRC scrambled by C-RNTI (prior to padding) until the payload size of the non-fallback DCI format with the CRC scrambled by C-RNTI is equal to the indicated payload size. Furthermore, each UE in the group may add a padding bit(s) (e.g., appending a zero bit(s)) to DCI format #2 (prior to padding) (e.g., DCI format 1_1 with the CRC scrambled by G-RNTI) until the payload size of the DCI format #2 is equal to the indicated payload size.

In a third embodiment of the present disclosure, the payload size of DCI format #2 may be determined as the maximum size of DCI format 2_X series with CRCs scrambled by corresponding RNTIs among the group of UEs. For example, the BS may determine a maximum size of DCI format 2_0 with a CRC scrambled by SFI-RNTI, DCI format 2_1 with a CRC scrambled by INT-RNTI, and DCI format 2_4 with a CRC scrambled by CI-RNTI, DCI format 2_5 with a CRC scrambled by AI-RNTI, DCI format 2_6 with a CRC scrambled by PS-RNTI.

After determining the payload size, the BS may indicate the determined size to the group of UEs via RRC signaling, message or parameter. In response to the reception of the size, each UE in the group may add a padding bit(s) (e.g., appending a zero bit(s)) to DCI format #2 (prior to padding) (e.g., DCI format 1_1 with the CRC scrambled by G-RNTI) until the payload size of the DCI format #2 is equal to the indicated payload size.

In a fourth embodiment of the present disclosure, the BS may indicate that each UE in the group to align its respective payload size of non-fallback format for UL transmission (e.g., DCI format 0_1) with the CRC scrambled by the UE-specific RNTI (e.g., C-RNTI) of the corresponding UE with its respective payload size of non-fallback format for DL transmission (e.g., DCI format 1_1) with the CRC scrambled by the UE-specific RNTI (e.g., C-RNTI) of the corresponding UE. For example, a UE may add a padding bit(s) (e.g., appending a zero bit(s)) to the DCI format with smaller payload size between DCI format 0_1 with the CRC scrambled by C-RNTI and DCI format 1_1 with the CRC scrambled by C-RNTI until both DCI formats have the same size.

Furthermore, the BS may determine the payload size of DCI format #2 as the maximum size of non-fallback DCI formats for DL transmission (e.g., DCI format 1_1s) with the CRCs scrambled by group-common RNTIs (e.g., G-RNTIs) (prior to padding) among the group of UEs as long as one UE of the group of UEs receives more than one MBS service. Each MBS service may correspond to a specific G-RNTI. After determining the payload size, the BS may indicate the determined size to the group of UEs via RRC signaling, message or parameter. In response to the reception of the size, each UE in the group may add a padding bit(s) (e.g., appending a zero bit(s)) to DCI format #2 (prior to padding) (e.g., DCI format 1_1 with the CRC scrambled by G-RNTI) until the payload size of DCI format #2 is equal to the indicated payload size.

Table 5 below shows exemplary DCI formats received by a UE and the associated RNTIs. In Table 5, 7 DCI formats and the associated RNTIs are listed. It should be understood that Table 5 is only for illustrative purposes, and should not be construed as limiting the embodiments of the present disclosure.

TABLE 5
DCI formats and associated RNTIs

| Type | DCI format and associated RNTI |
|---|---|
| A | DCI format 0_0 with CRC scrambled by C-RNTI |
| B | DCI format 1_0 with CRC scrambled by C-RNTI |
| C | DCI format 1_0 with CRC scrambled by G-RNTI |
| D | DCI format 0_1 with CRC scrambled by C-RNTI |
| E | DCI format 1_1 with CRC scrambled by C-RNTI |
| F | DCI format 1_1 with CRC scrambled by G-RNTI |
| G | DCI format 2_X series with CRC scrambled by |
| | corresponding RNTI |

Among the above 7 DCI formats (hereinafter, respectively denoted as DCI formats A-G as shown in the table for simplicity), the payload size of DCI format A may be always aligned with that of DCI format B. Also, as mentioned above, the payload size of DCI format C may be aligned with that of DCI format B.

According to the above first embodiment, the payload size of both DCI format E and DCI format F may be aligned to the maximum payload size of DCI formats E among the group of UEs and DCI format F prior to padding. According to the above second embodiment, the payload size of both DCI format E and DCI format F may be aligned to the maximum payload size of DCI formats E among the group of UEs. According to the above third embodiment, the payload size of DCI format F may be aligned to the maximum payload size of DCI formats G among the group of UEs prior to padding. According to the above fourth embodiment, DCI format E and DCI format F may perform size alignment, and the payload size of DCI format F may be aligned to DCI formats F (prior to padding) among the group of UEs when, for example, one member UE of the group of UEs receives more than one MBS service. In this way, the “3+1” DCI size budge is kept.

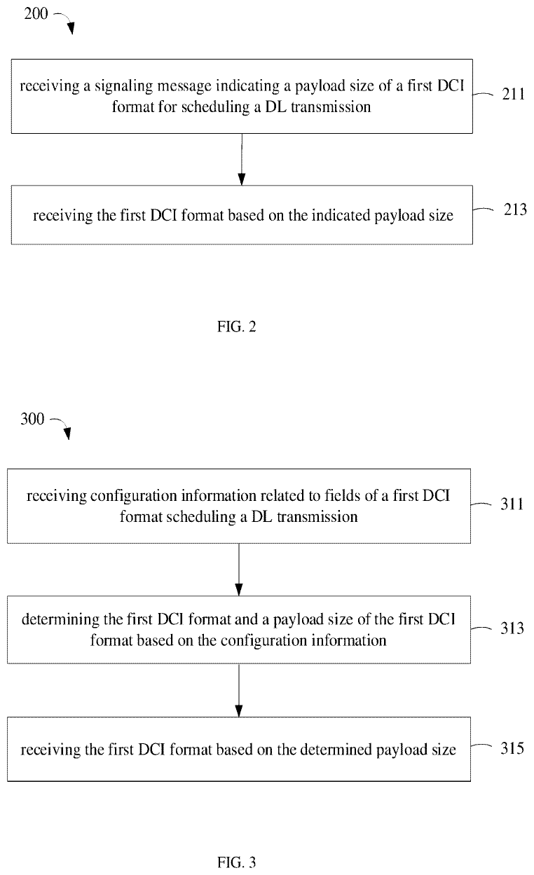

FIG. 2 illustrates a flow chart of an exemplary procedure 200 for wireless communications in accordance with some embodiments of the present disclosure. Details described in all of the foregoing embodiments of the present disclosure are applicable for the embodiments shown in FIG. 2. In some examples, the procedure may be performed by a UE, for example, UE 101 in FIG. 1.

Referring to FIG. 2, in operation 211, a UE may receive a signaling message indicating a payload size of a first DCI format for scheduling a DL transmission. The first DCI format and the DL transmission are common to a group of UEs including the UE. For example, the first DCI format may be DCI format #1 or DCI format #2 as described above.

For instance, in some embodiments, the HARQ-ACK feedback related fields in the first DCI format may be arranged at the end of the first DCI format. In some examples, the HARQ-ACK feedback related fields in the first DCI format may be arranged at the end of the first DCI format in an order based on their usage frequencies among different HARQ-ACK feedback options.

In some embodiments, the UE may determine the first DCI format based on configuration information for the DL transmission. For example, the UE may determine whether a specific field exist or not in the first DCI format or whether the size of the specific field is equal to 0. For example, the UE may determine the size of BWP indicator field based on the BWP configuration of the UE. For example, the UE may determine the size of the TDRA field based on a configured TDRA table. The UE may align the size of the determined first DCI format to the indicated payload size. For example, the UE may add a padding bit(s) to the determined first DCI format until the size of the determined first DCI format is equal to the indicated payload size.

In some examples, the indicated payload size may be the maximum size among all non-fallback DCI formats for scheduling DL transmission (e.g., DCI format 1_1s) with CRCs scrambled by UE-specific RNTIs of the group of UEs and the determined first DCI format. In some examples, the indicated payload size may be the maximum size among all non-fallback DCI formats for scheduling DL transmission (e.g., DCI format 1_1s) with CRCs scrambled by UE-specific RNTIs of the group of UEs. In some examples, the indicated payload size may be the maximum size among all DCI format 2_X series with CRCs scrambled by corresponding RNTIs of the group of UEs.

In some examples, the signaling message may further indicate the UE to perform a size alignment between a non-fallback DCI format for scheduling UL transmission (e.g., DCI format 0_1) with a CRC scrambled by a RNTI specific to the UE and a non-fallback DCI format for scheduling DL transmission (e.g., DCI format 1_1) with a CRC scrambled by the RNTI specific to the UE. The indicated payload size may be the maximum size among all non-fallback DCI formats for scheduling DL transmission (e.g., DCI format 1_1) with CRCs scrambled by group-common RNTIs of the group of UEs.

In operation 213, the UE may receive the first DCI format based on the indicated payload size.

It should be appreciated by persons skilled in the art that the sequence of the operations in exemplary procedure 200 may be changed and some of the operations in exemplary procedure 200 may be eliminated or modified, without departing from the spirit and scope of the disclosure.

FIG. 3 illustrates a flow chart of an exemplary procedure 300 for wireless communications in accordance with some embodiments of the present disclosure. Details described in all of the foregoing embodiments of the present disclosure are applicable for the embodiments shown in FIG. 3. In some examples, the procedure may be performed by a UE, for example, UE 101 in FIG. 1.

Referring to FIG. 3, in operation 311, a UE may receive configuration information related to fields of a first DCI format scheduling a DL transmission. The first DCI format and the DL transmission are common to a group of UEs including the UE. For example, the first DCI format may be DCI format #1 or DCI format #2 as described above. In operation 313, the UE may determine the first DCI format and a payload size of the first DCI format based on the configuration information. In operation 315, the UE may receive the first DCI format based on the determined payload size.

In some embodiments, the configuration information may indicate whether a HARQ-ACK feedback related field for the DL transmission is present or not in the first DCI format. In some embodiments, the configuration information may indicate whether a combination of at least two HARQ-ACK feedback related fields for the DL transmission is present or not in the first DCI format. The configuration information may be received in a SIB, an MCCH, or a UE-specific RRC signaling.

In some embodiments, at least one HARQ-ACK related field in the first DCI format may be reused for a FDRA indication in the first DCI format based on a predefined or configured order.

In some embodiments, the configuration information may indicate a corresponding size for each field with a configurable size in the first DCI format. The size of a field with a configurable size in the first DCI format may be the maximum size of the field among all non-fallback DCI formats for scheduling DL transmission (e.g., DCI format 1_1) with CRCs scrambled by group-common RNTIs of the group of UEs.

In some other embodiments, instead of indicating the field size by the configuration information, the UE may assume, for each field in a non-fallback DCI format for scheduling DL transmission (e.g., DCI format 1_1), the largest possible size of a corresponding field of the non-fallback DCI format as the size of the corresponding field. The non-fallback DCI format may be DCI format #2 (e.g., DCI format 1_1 with a CRC scrambled by G-RNTI) or DCI format 1_1 with a CRC scrambled by UE-specific RNTI.

It should be appreciated by persons skilled in the art that the sequence of the operations in exemplary procedure 300 may be changed and some of the operations in exemplary procedure 300 may be eliminated or modified, without departing from the spirit and scope of the disclosure.

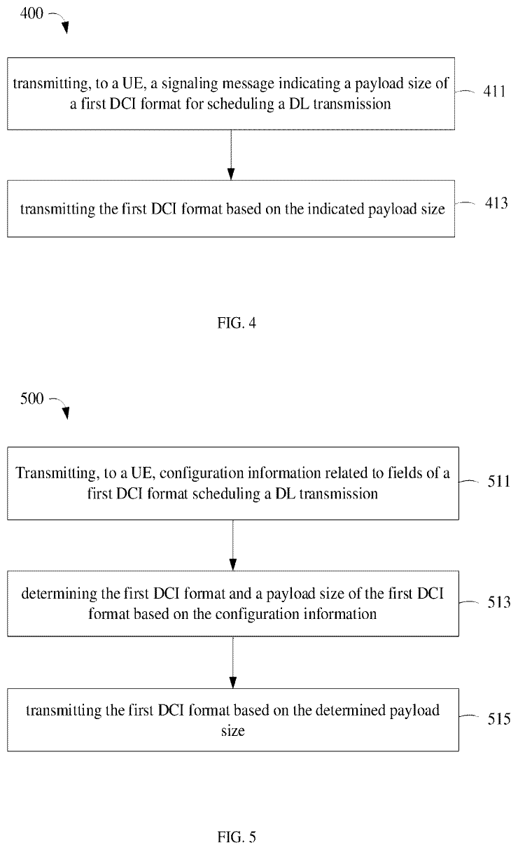

FIG. 4 illustrates a flow chart of an exemplary procedure 400 for wireless communications in accordance with some embodiments of the present disclosure. Details described in all of the foregoing embodiments of the present disclosure are applicable for the embodiments shown in FIG. 4. In some examples, the procedure may be performed by a BS, for example, BS 102 in FIG. 1.

Referring to FIG. 4, in operation 411, a BS may transmit, to a UE, a signaling message indicating a payload size of a first DCI format for scheduling a DL transmission. The first DCI format and the DL transmission are common to a group of UEs including the UE. For example, the first DCI format may be DCI format #1 or DCI format #2 as described above.

In some embodiments, the HARQ-ACK feedback related fields in the first DCI format may be arranged at the end of the first DCI format. For example, the HARQ-ACK feedback related fields in the first DCI format may be arranged at the end of the first DCI format in an order based on their usage frequencies among different HARQ-ACK feedback options.

In some embodiments, the BS may determine the first DCI format based on configuration information for the DL transmission. The BS may add a padding bit(s) to the determined first DCI format until the size of the determined first DCI format is equal to the indicated payload size.

In some examples, the indicated payload size may be the maximum size among all non-fallback DCI formats for scheduling DL transmission (e.g., DCI format 1_1s) with CRCs scrambled by UE-specific RNTIs of the group of UEs and the determined first DCI format. In some examples, the indicated payload size may be the maximum size among all non-fallback DCI formats for scheduling DL transmission (e.g., DCI format 1_1s) with CRCs scrambled by UE-specific RNTIs of the group of UEs. In some examples, the indicated payload size may be the maximum size among all DCI format 2_X series with CRCs scrambled by corresponding RNTIs of the group of UEs.

In some examples, the signaling message may further indicate the UE to perform a size alignment between a non-fallback DCI format for scheduling UL transmission (e.g., DCI format 0_1) with a CRC scrambled by a RNTI specific to the UE and a non-fallback DCI format for scheduling DL transmission (e.g., DCI format 1_1) with a CRC scrambled by the RNTI specific to the UE. The indicated payload size may be the maximum size among all non-fallback DCI formats for scheduling DL transmission (e.g., DCI format 1_1) with CRCs scrambled by group-common RNTIs of the group of UEs.

In operation 413, the BS may transmit the first DCI format based on the indicated payload size.

It should be appreciated by persons skilled in the art that the sequence of the operations in exemplary procedure 400 may be changed and some of the operations in exemplary procedure 400 may be eliminated or modified, without departing from the spirit and scope of the disclosure.

FIG. 5 illustrates a flow chart of an exemplary procedure 500 for wireless communications in accordance with some embodiments of the present disclosure. Details described in all of the foregoing embodiments of the present disclosure are applicable for the embodiments shown in FIG. 5. In some examples, the procedure may be performed by a BS, for example, BS 102 in FIG. 1.

Referring to FIG. 5, in operation 511, a BS may transmit, to a UE, configuration information related to fields of a first DCI format scheduling a DL transmission. The first DCI format and the DL transmission are common to a group of UEs including the UE. For example, the first DCI format may be DCI format #1 or DCI format #2 as described above. In operation 513, the BS may determine the first DCI format and a payload size of the first DCI format based on the configuration information. In operation 515, the BS may transmit the first DCI format based on the determined payload size.

In some embodiments, the configuration information may indicate whether a HARQ-ACK feedback related field for the DL transmission is present or not in the first DCI format. In some embodiments, the configuration information may indicate whether a combination of at least two HARQ-ACK feedback related fields for the DL transmission is present or not in the first DCI format. The configuration information may be transmitted in a SIB, an MCCH, or a UE-specific RRC signaling.

In some embodiments, at least one HARQ-ACK related field in the first DCI format may be reused for a FDRA indication in the first DCI format based on a predefined or configured order.

In some embodiments, the configuration information may indicate a corresponding size for each field with a configurable size in the first DCI format. The BS may determine the maximum size of a field with a configurable size in the first DCI format among all non-fallback DCI formats for scheduling DL transmission (e.g., DCI format 1_1) with CRCs scrambled by group-common RNTIs of the group of UEs as the size of the field.

In some other embodiments, instead of indicating the field size by the configuration information, the BS may determine, for each field in a non-fallback DCI format for scheduling DL transmission (e.g., DCI format 1_1), the largest possible size of a corresponding field of the non-fallback DCI format as the size of the corresponding field. The non-fallback DCI format may be DCI format #2 (e.g., DCI format 1_1 with a CRC scrambled by G-RNTI) or DCI format 1_1 with a CRC scrambled by UE-specific RNTI.

It should be appreciated by persons skilled in the art that the sequence of the operations in exemplary procedure 500 may be changed and some of the operations in exemplary procedure 500 may be eliminated or modified, without departing from the spirit and scope of the disclosure.

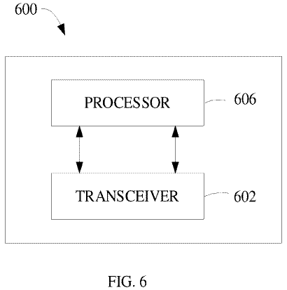

FIG. 6 illustrates a block diagram of an exemplary apparatus 600 according to some embodiments of the present disclosure. Details described in all of the foregoing embodiments of the present disclosure are applicable for the embodiments shown in FIG. 6.

As shown in FIG. 6, the apparatus 600 may include at least one processor 606 and at least one transceiver 602 coupled to the processor 606. The apparatus 600 may be a UE or a BS.

Although in this figure, elements such as the at least one transceiver 602 and processor 606 are described in the singular, the plural is contemplated unless a limitation to the singular is explicitly stated. In some embodiments of the present application, the transceiver 602 may be divided into two devices, such as a receiving circuitry and a transmitting circuitry. In some embodiments of the present application, the apparatus 600 may further include an input device, a memory, and/or other components.

In some embodiments of the present application, the apparatus 600 may be a UE. The transceiver 602 and the processor 606 may interact with each other so as to perform the operations with respect to the UE described in FIGS. 1-5. In some embodiments of the present application, the apparatus 600 may be a BS. The transceiver 602 and the processor 606 may interact with each other so as to perform the operations with respect to the BS described in FIGS. 1-5.

In some embodiments of the present application, the apparatus 600 may further include at least one non-transitory computer-readable medium.

For example, in some embodiments of the present disclosure, the non-transitory computer-readable medium may have stored thereon computer-executable instructions to cause the processor 606 to implement the method with respect to the UE as described above. For example, the computer-executable instructions, when executed, cause the processor 606 interacting with transceiver 602, so as to perform the operations with respect to the UE described in FIGS. 1-5.

In some embodiments of the present disclosure, the non-transitory computer-readable medium may have stored thereon computer-executable instructions to cause the processor 606 to implement the method with respect to the BS as described above. For example, the computer-executable instructions, when executed, cause the processor 606 interacting with transceiver 602 to perform the operations with respect to the BS described in FIGS. 1-5.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A user equipment (UE), comprising:
at least one memory; and
at least one processor coupled with the at least one memory and configured to cause the UE to:
receive a signaling message indicating a payload size of a first downlink control information (DCI) format for scheduling a downlink (DL) transmission, wherein the first DCI format and the DL transmission are common to a group of UEs including the UE; and
receive the first DCI format based on the indicated payload size.

2. The UE of claim 1, wherein hybrid automatic repeat request acknowledgement (HARQ-ACK) feedback related fields in the first DCI format are arranged at an end of the first DCI format.

3. The UE of claim 2, wherein the HARQ-ACK feedback related fields in the first DCI format are arranged at the end of the first DCI format in an order based on their usage frequencies among different HARQ-ACK feedback options.

4. The UE of claim 1, wherein the at least one processor is further configured to cause the UE to:
determine the first DCI format based on configuration information for the DL transmission; and
align a size of the determined first DCI format to the indicated payload size by adding one or more padding bits to the determined first DCI format until the size of the determined first DCI format is equal to the indicated payload size.

5. The UE of claim 4, wherein the indicated payload size is:
a maximum size among all non-fallback DCI formats for scheduling the DL transmission with cyclic redundancy checks (CRCs) scrambled by UE-specific radio network temporary identifiers (RNTIs) of the group of UEs and the determined first DCI format;
the maximum size among all of the non-fallback DCI formats for scheduling the DL transmission with the CRCs scrambled by the UE-specific RNTIs of the group of UEs; or
the maximum size among all DCI format 2_X series with the CRCs scrambled by corresponding RNTIs of the group of UEs.

6. The UE of claim 4, wherein the signaling message further indicates the UE to perform a size alignment between a non-fallback DCI format for scheduling an uplink (UL) transmission with a cyclic redundancy check (CRC) scrambled by a radio network temporary identifier (RNTI) specific to the UE and a non-fallback DCI format for scheduling a DL transmission with the CRC scrambled by the RNTI specific to the UE.

7. The UE of claim 6, wherein the indicated payload size is a maximum size among all non-fallback DCI formats for scheduling the DL transmission with CRCs scrambled by group-common RNTIs of the group of UEs.

8. A user equipment (UE), comprising:
at least one memory; and
at least one processor coupled with the at least one memory and configured to cause the UE to:
receive configuration information related to fields of a first downlink control information (DCI) format scheduling a downlink (DL) transmission, wherein the first DCI format and the DL transmission are common to a group of UEs including the UE;
determine the first DCI format and a payload size of the first DCI format based on the configuration information; and
receive the first DCI format based on the determined payload size.

9. The UE of claim 8, wherein the configuration information indicates:
whether a hybrid automatic repeat request acknowledgement (HARQ-ACK) feedback related field for the DL transmission is present or not in the first DCI format; or
whether a combination of at least two HARQ-ACK feedback related fields for the DL transmission is present or not in the first DCI format.

10. The UE of claim 8, wherein the configuration information is received in a system information block (SIB), a multicast control channel (MCCH), or a UE-specific radio resource control (RRC) signaling.

11. The UE of claim 8, wherein at least one hybrid automatic repeat request acknowledgement (HARQ-ACK) related field in the first DCI format is reused for a frequency domain resource allocation (FDRA) indication in the first DCI format based on a predefined order or a configured order.

12. The UE of claim 8, wherein the configuration information indicates a corresponding size for each field with a configurable size in the first DCI format.

13. The UE of claim 12, wherein the size of a field with the configurable size in the first DCI format is a maximum size of the field among all non-fallback DCI formats for scheduling a DL transmission with CRCs scrambled by group-common radio network temporary identifiers (RNTIs) of the group of UEs.

14. (canceled)

15. A processor for wireless communication, comprising:
at least one controller coupled with at least one memory and configured to cause the processor to:
receive a signaling message indicating a payload size of a first downlink control information (DCI) format for scheduling a downlink (DL) transmission, wherein the first DCI format and the DL transmission are common to a group of UEs; and
receive the first DCI format based on the indicated payload size.

16. A base station (BS) for wireless communication, comprising:
at least one memory; and
at least one processor coupled with the at least one memory and configured to cause the BS to:
transmit, to a user equipment (UE), a signaling message indicating a payload size of a first downlink control information (DCI) format for scheduling a downlink (DL) transmission, wherein the first DCI format and the DL transmission are common to a group of UEs including the UE; and
transmit the first DCI format based on the indicated payload size.

17. The BS of claim 16, wherein hybrid automatic repeat request acknowledgement (HARQ-ACK) feedback related fields in the first DCI format are arranged at an end of the first DCI format in an order based on usage frequencies among different HARQ-ACK feedback options.

18. The BS of claim 16, wherein the at least one processor is configured to cause the BS to:
determine the first DCI format based on configuration information for the DL transmission; and
add one or more padding bits to the determined first DCI format until the size of the determined first DCI format is equal to the indicated payload size.

19. The BS of claim 18, wherein the indicated payload size is:
a maximum size among all non-fallback DCI formats for scheduling the DL transmission with cyclic redundancy checks (CRCs) scrambled by UE-specific radio network temporary identifiers (RNTIs) of the group of UEs and the determined first DCI format;
the maximum size among all of the non-fallback DCI formats for scheduling the DL transmission with the CRCs scrambled by the UE-specific RNTIs of the group of UEs; or
the maximum size among all DCI format 2_X series with the CRCs scrambled by corresponding RNTIs of the group of UEs.

20. The BS of claim 18, wherein the signaling message indicates the UE to perform a size alignment between a non-fallback DCI format for scheduling an uplink (UL) transmission with a cyclic redundancy check (CRC) scrambled by a radio network temporary identifier (RNTI) specific to the UE and a non-fallback DCI format for scheduling a DL transmission with the CRC scrambled by the RNTI specific to the UE.

21. The BS of claim 20, wherein the indicated payload size is a maximum size among all non-fallback DCI formats for scheduling the DL transmission with CRCs scrambled by group-common RNTIs of the group of UEs.
